(19) United States
(12) Patent Application Publication
(10) Pub. No.: US 2008/0135154 A1
(43) Pub. Date: Jun. 12, 2008

(54) Tire Bead Facilitating Mounting and Method For Making Such a Bead

(76) Inventors: Nicolas Janin, Riom (FR); Guy Cagneaux, Nohanent (FR)

Correspondence Address: BUCHANAN, INGERSOLL & ROONEY PC, POST OFFICE BOX 1404, ALEXANDRIA, VA, 22313-1404, US

(21) Appl. No.: 11/793,487

(22) PCT Filed: Dec. 6, 2005
(86) PCT No.: PCT/EP2005/056515

§ 371 Date: Jun. 21, 2007

(30) Foreign Application Priority Data
Dec. 24, 2004 (FR) 0413957

(51) Int. Cl. B60C 15/024; B29D 30/48

(52) U.S. Cl. 152/544; 156/136

(57) ABSTRACT

Tire designed to be mounted on a mounting rim comprising rim seats 11 that are inclined outwards. This tire comprises beads 1 designed to come into contact with the mounting rim, each bead having a circumferential reinforcing element which serves to anchor to a carcass reinforcement, this element having a center of rotation about which this element is able to rotate while the bead is being mounted on the rim. This bead has an external profile 8 which, viewed in meridian cross section, comprises a bead seat forming part 81, a side wall 83 and a connecting profile 82 connecting the seat and the side wall, at least one bead being such that the maximum distance L1 from the center of rotation of the bead reinforcing element to the points on the lateral profile 82 of the bead and the minimum distance L0 from the center of rotation of the circumferential bead reinforcement to the points on the lateral profile 83 of the bead satisfy the following relationship:

K<1%, where K=(L1−L0)/L1

The present invention relates to a radial tire designed to be mounted on a rim at least one seat of which is inclined outwards and extended axially outwards by a low projection or hump. It relates more specifically to the beads of such a tire.

A tire designed to be mounted on a rim at least one seat of which is inclined outwards is described, for example, in international publication WO 95/23073.

The structure of the beads of such tire assemblies is described in international publication WO 95/23073 and in particular comprises a part forming a heel designed to lie axially towards the inside of the tire and a bead toe designed to lie axially on the outside when the tire is mounted on its mounting rim. The external profile of each bead comprises a succession of parts, namely a bead seat designed to come into contact with a rim seat and, axially on the outside, a bead side part designed to come into contact with a rim seat which lies axially on the outside in the continuation of the seat of the rim.

This tire further comprises a carcass reinforcement, the ends of which are anchored in each bead to an anchoring device, said anchoring device being formed of at least one circumferential bead reinforcing element (such as a bead wire or a collection of circumferentially wound cords or cables) and a wedge of a high-hardness rubber blend of more or less triangular shape. When viewed in meridian cross section (that is to say in section on a plane containing the axis of rotation of the tire), this wedge is bounded by a radially outer side face and a radially inner face and finally by a face connecting the previous two faces and lying axially on the outside, so that the vertex of the wedge that is opposite said side face lies radially towards the inside of the circumferential bead reinforcing element. The carcass reinforcement is anchored at each of its ends to said anchoring device by means of an at least partial doubling-back around the circumferential bead reinforcing element and extends into or around the wedge of high-hardness rubber blend.

Furthermore, an internal support designed to provide support in the event of a partial or complete loss of tire inflation pressure is also mounted with this tire.

U.S. Pat. No. 5,836,366 describes such a tire assembly formed of a tire, a mounting rim and a support ring. That document in particular describes a method of mounting the tire and the internal support on the mounting rim. This method is described in particular using FIGS. 2A to 2D of said patent. According to that method, the beads, in order to be fitted onto the mounting rim, need first of all to be moved axially towards the outside of the rim before being positioned on their respective seats.

In the latter mounting operation, the bead is once again partially engaged on its seat (that is to say over a broad angular sector corresponding to over 180°), until mounting is completely finished using conventional mounting tools. During the latter operation it has been found that there were difficulties in passing the bead over the projection (hump) of the rim: these difficulties resulted in increased forces on the bead and a risk of damaging said bead or alternatively a risk of poor placement of the bead on the rim, with all its potential consequences.

It is an object of the invention to propose a bead geometry of a tire that is mounted on a rim in which at least one seat is inclined outwards so that it is easier for the tire to be mounted on its mounting rim while at the same time ensuring that it is mounted correctly thereon. It is another object of the invention to propose a method of constructing beads for tires to be mounted on a rim in which at least one seat is inclined outwards.

The tire according to the invention is designed to be mounted on a mounting rim comprising rim seats that are inclined outwards, that is to say that these rim seats have, viewed in section on a plane containing the axis of rotation, a frustoconical shape, the straight generatrix of which is inclined with respect to the axis of rotation, the axially outermost points of each generatrix lying on a circle of a diameter smaller than that of the circle on which the axially innermost points of the same generatrix lie, each seat being extended axially outwards by a projection (or hump). This hump is, viewed in meridian cross section (that is to say in a plane containing the axis of rotation), connected to the generatrix of the seat by a connecting arc of a circle of radius R.

According to the invention, the tire comprises beads designed to come into contact with said mounting rim, each bead comprising a circumferential reinforcement designed to anchor a carcass reinforcement of the tire, the external profile of the bead, viewed in meridian cross section, comprising a bead seat forming part, this part being designed to come into contact with the rim seat, this bead seat being extended axially and radially outwards by a side wall designed to come into contact with the hump of the mounting rim, the bead seat being connected to the side wall by a connecting profile. This tire is characterized in that at least one bead is such that the maximum distance L1 from the center of rotation of the circumferential bead reinforcement to the points on the connecting profile and the minimum distance L0 from the center of rotation of the circumferential bead reinforcement to the lateral bead profile satisfy the following relationship: K<1%, where K=(L1−LO)/L1.

The center of rotation of the circumferential bead reinforcement is to be understood as meaning the center of rotation of the cross section of said reinforcement, viewed in a meridian plane (that is to say a plane containing the axis of rotation) in the final movement of the fitting of the last bead onto the rim. In practice, in this last stage of the fitting, this center of rotation is more or less fixed with respect to the rim once the circumferential bead reinforcement is practically in position over a broad angular sector (that is to say over a long circumferential length). It is in this configuration that the distances to said center of rotation are measured.

With a bead according to the invention it is possible to significantly reduce the forces involved in passing over the hump, particularly the compressive and shear stresses in the materials present between the circumferential bead reinforcement and the bead connecting profile.

As a preference, the ratio K is chosen such that the compressive stresses are very much lower than the compressive stress in the material of the bead in contact with the rim and corresponding to a compressive deformation of 1%.

Advantageously, this ratio K is lower than 0.6%.

A bead according to the invention usually entails having a connecting profile connecting the bead seat and the side wall of said bead which, once the tire is mounted on its mounting rim and inflated to its nominal pressure, does not touch the bead seat connecting arc.

The invention can be implemented on one of the beads of a tire or preferably on both beads.

Another subject of the invention is a method of constructing the outer profile of a tire bead intended to be mounted on a mounting rim making it easier to mount the tire on its mounting rim, this mounting rim comprising rim seats that are inclined outwards, that is to say that these rim seats have a frustoconical shape, the generatrix of which is inclined with respect to the axis of rotation, the axially outermost points of each generatrix lying on a circle of a diameter smaller than that of the circle on which the axially innermost points of the same generatrix lie, each seat being extended axially outwards by a projection (or hump), this hump having a frustoconical wall, the generatrix of which is inclined in such a way as to be more or less perpendicular to the generatrix of the seat that it extends, said wall generatrix of the hump being, viewed in meridian cross section (that is to say in a plane containing the axis of rotation), connected to the generatrix of the seat by a connecting arc of a circle of radius R.

Furthermore, this tire comprises beads designed to come into contact with said mounting rim, each bead comprising a circumferential reinforcement designed to anchor a carcass reinforcement of the tire, the external profile of the bead, viewed in meridian cross section, comprising a bead seat forming part, this part being designed to come into contact with the rim seat, this bead seat being extended axially and radially outwards by a side wall designed to come into contact with the wall of the hump of the mounting rim, a connecting profile connecting the bead seat to the side wall of said bead.

The construction method according to the invention is characterized in that:
the profile of the rim, comprising in particular the profile of the seat, the profile of the hump and the profile of the connecting profile between this seat and this hump is scanned in a plane containing the axis of rotation;
the circumferential bead reinforcement is placed in the position that it occupies once the tire has been mounted on its rim;
the external bead profile is constructed from the rim profile, that is to say at least partially reproducing the profile of the rim seat and at least partially reproducing the profile of the rim hump, the connecting profile of the bead profile being constructed in such a way that it lies radially on the outside of the rim profile.

A connecting profile radially on the outside of a given geometric profile is to be understood here as meaning that all or practically all of the points of said connecting profile are at a greater distance from the axis of rotation of the tire than the distance of the corresponding point on the geometric profile, the corresponding point being obtained as the intersection of a straight line perpendicular to the axis of rotation and passing through the point of the connecting profile. The exception mentioned applies at least to the end points of the connecting profile.

This construction is improved in terms of the compressive deformations of the materials of which the bead is made once the tire is in place on its mounting rim, that is to say by modifying the bead seat and side wall profiles in such a way as to add the compressive deformations of the materials of which the bead is made as a result of the mounting of the tire on its rim. Adding the compressive deformations is to be understood here as meaning that the bead seat profile is offset radially inwards with respect to the seat profile of the rim by an amount that corresponds to said compressive deformations.

Other features and advantages of the invention will become apparent from the description given hereinafter with reference to the attached drawings which, by way of nonlimiting examples, show some embodiments of the subject of the invention.

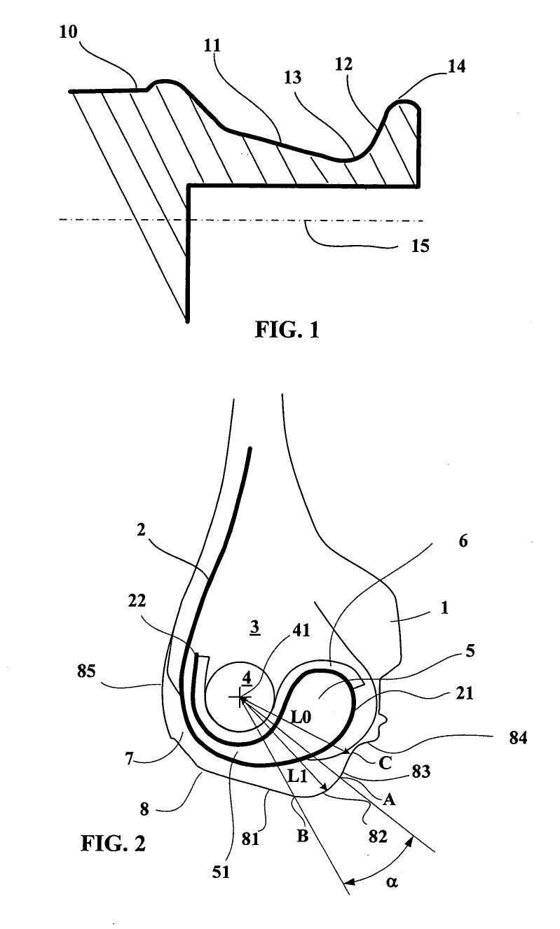

FIG. 1 depicts partially, in cross section, a rim, the seat of which is inclined outwards and intended to accept a tire bead;

FIG. 2 depicts partially, in cross section, a bead according to the invention;

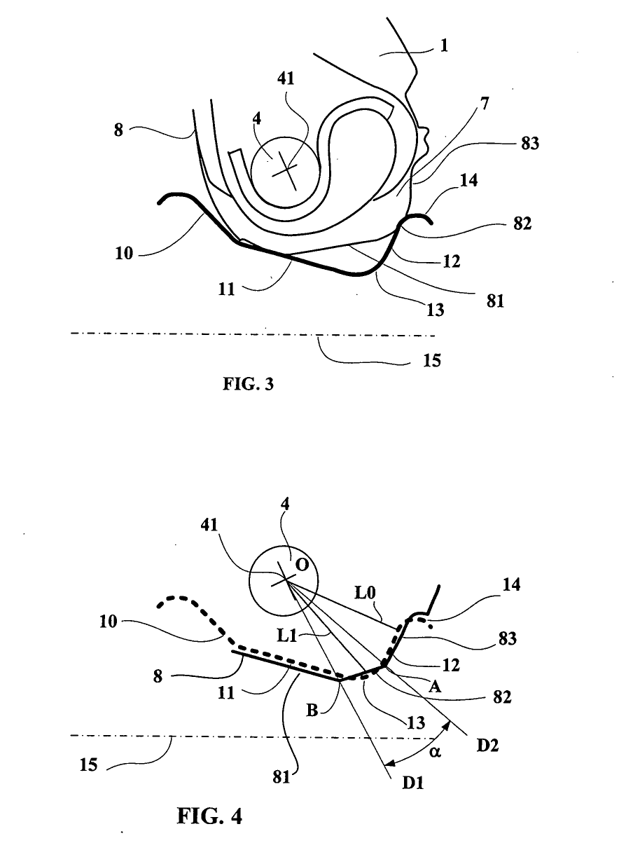

FIG. 3 depicts a cross section through the bead of FIG. 2 in an intermediate phase in the mounting on its rim as shown in FIG. 1;

FIG. 4 schematically illustrates the construction of a bead according to the invention, from a rim profile.

To make it easier to understand, the description which follows uses the same reference symbols to denote elements which are similar so these reference symbols denote elements which are identical at least in terms of their function.

FIG. 1 shows a meridian cross section through a mounting rim 10 of a tire, at least one seat 11 of which is said to be “inclined outwards”, that is to say one in which the axially innermost points lie on a circle of a diameter larger than the one on which the axially outermost points lie. This rim 10 comprises a more or less straight seat 11 inclined by an angle of 15° with respect to the axis of rotation 15. This seat 11 is extended axially and radially outwards by a projection or hump, the axially inner wall 12 of which is in the shape of an arc of a circle with a concave face facing towards the inside of the rim. This wall 12 of the hump is extended radially outwards by a lip 14. Finally, the seat 11 is connected to the wall of the hump 12 by a connecting profile 13 in the form of a circular arc.

A view in meridian cross section is to be understood here to mean that the figure is produced in a plane of section containing the axis of rotation of the tire. Likewise, “radially on the inside of an element” is to be understood as meaning a position located between said element and the axis of rotation of the tire, and “axially on the inside of” is to be understood as meaning a position lying on the same side as the cavity that limits the tire inflation pressure.

FIG. 2 shows, in meridian cross section (that is to say in cross section on a plane containing the axis of rotation) a bead 1 of a tire designed to be mounted on a rim as shown with FIG. 1. This bead 1 comprises a carcass reinforcement 2 one end of which passes radially under a bead wire 4 forming a circumferential reinforcement to form a loop 21 surrounding a profiled core 5 made of a blend of hard rubber, said core 5 having the shape of a wedge, one tip 51 of which is positioned radially under the bead wire 4. Having made a complete turn of the profile 5, the end 22 of the carcass reinforcement 2 is wedged axially against the reinforcement itself and the bead wire 4.

In this instance, the two beads of the tire of a size 205-650 R 440 A are constructed in accordance with the invention and accordingly allow for easier mounting of said two beads.

This bead 1 further comprises a first rubber blend forming a protector or chafer 7 designed to be in contact with the rim when the tire is mounted on its mounting rim (size 205×440): this chafer 7 blend is chosen for its rubbing wear performance and its ability to withstand compression.

Another rubber blend forms a screen 6 between the carcass reinforcement 2 and the bead wire 4 and thus prevents any risk of direct contact. The bead wire 4 is of circular cross section and formed of a plurality of metal cords twisted together; this bead wire is surmounted by a filling material 3.

FIG. 1 also shows the external profile or contour 8 of the bead. This profile 8 is formed of a succession of profile parts: an internal part 85 corresponds to that part of the profile 8 which is not in contact with the rim, a seat part 81 designed more specifically to come into contact with the seat of a rim, a more or less straight side part 83 designed to come into contact with the rim hump, a connecting part 82 providing the connection between the seat 81 and side 83 parts.

The profile 81 ends at a point B and is continued from this point B as far as a point A via the connecting profile 82. The angle α subtended at the center of the bead wire 4 by the points A and B is, in this instance, equal to 22°. Advantageously, this angle is at least equal to 10°. The side profile 83 is extended axially and radially outwards by a curved profile 84 forming the radially outermost part of the rim hump. This curved part 84 meets the side profile 83 tangentially at a point C.

In the bead 1 according to the invention, the connecting profile 82 and the side profile 83 are such that, if L1 is used to denote the maximum distance between the center of rotation 41 of the bead wire 4, and the part of the connecting profile 82 and L0 is used to denote the minimum distance between the same center of rotation 41 and the side part 83, the ratio K, defined as the ratio ((L1−L0)/L1), is at most equal to 1% ( 1/100). In this instance, the value of this ratio K is 0.51% ( 0.51/100).

FIG. 3 shows the bead 1 of FIG. 2 while it is in the process of being mounted on a rim 10 as shown in FIG. 1. This configuration reveals a section, measured over a circumferential sector, which has not yet been mounted: with the exception of this sector, the bead is in place on its rim over the majority of the circumference of the wheel. In this position, it can be seen that the bead is mounted by a kind of rotation or twisting about the geometric center 41 of the bead wire 4 with practically no movement in the axial direction, given the very great extensile stiffness of the bead wire in the circumferential direction. In this rotational movement (which here is equivalent to a localized twisting) the connecting part 82 of the external profile 8 of the bead comes into contact with the part 14 of the rim hump.

With the chosen values of L1 and L0 it is thus possible to limit the shear and compressive forces in the chafer 7 blend and thus make mounting easier while at the same time avoiding any risk of damaging the bead during this last phase of the fitting.

FIG. 4 is now used to explain a method of constructing an external profile 8 of a bead according to the invention. To do this, the profile of a mounting rim 10, depicted in dotted line in FIG. 4, is first of all plotted. The circumferential bead reinforcement, in this case a bead wire 4, for which it is specified that the center of rotation 41 in torsional deformation lies in the plane of the figure (the plane containing the axis of rotation 15) is then positioned. The bead seat profile 81 is then constructed, offsetting it radially inwards (that is to say towards the axis of rotation) with respect to the rim seat profile 11 so as to take account of the compression of the materials of which the bead is made between the bead wire and the rim seat. This seat profile 81 extends axially outwards as far as a point B and may, for example, adopt a profile more or less identical and parallel to that of the rim seat 11. Of course, any other shape of profile may be appropriate.

Next, a side profile 83 is constructed which is axially offset outwards with respect to the side profile 12 of the rim hump. This profile extends from a point A and is offset by an amount that takes account of the compression of the materials of the bead against the hump 12 once the bead is in place.

To finish, the connecting profile providing the connection between the point B of the seat profile and the point A of the side profile is chosen to be such that the maximum distance L1 from the center of rotation 41 of the bead wire 4 to any point on the connecting profile 82, with the exception of the end points A and B of said connecting profile, and the minimum distance L0 from said center of rotation 41 of the side profile 83, satisfy the relationship: (L1−L0)/L1<1%.

In this instance, the profile between A and B is at least partially radially on the outside of the connecting profile of the rim that connects the rim seat to the hump of the same rim. This profile may be more or less straight or adopt any other geometric shape.

The connecting profile 82 connecting points A and B forms a sector subtending an angle at the center of rotation 41 of the bead wire 4 and bounded by a straight line D1 passing through the point B and a straight line D2 passing through the point A. As a preference, the angle α subtended by this sector is at least equal to 10°.

1. A tire designed to be mounted on a mounting rim comprising rim seats (11) that are inclined outwards, that is to say that these rim seats (11) have a frustoconical shape, the generatrix of which is inclined with respect to the axis of rotation, the axially outermost points of each generatrix lying on a circle of a diameter smaller than that of the circle on which the axially innermost points of the same generatrix lie, each seat (11) being extended axially outwards by a projection (12) (or hump), this hump, viewed in meridian cross section, being connected to the generatrix of the seat by a connecting profile (13), the tire comprising beads designed to come into contact with the mounting rim, each bead 1 comprising a circumferential reinforcement 4 designed to anchor a carcass reinforcement 2 of the tire, the circumferential reinforcement 4 having a center of rotation 41 about which said reinforcement 4, when viewed in a meridian plane (that is to say a plane containing the axis of rotation) rotates during the final movement of fitting the bead onto the rim, the external profile 8 of the bead, viewed in meridian cross section, comprising a bead seat forming part (81), this part (81) being designed to come into contact with the rim seat (11), this bead seat (81) being extended axially and radially outwards by a side wall (83) designed to come into contact with the frustoconical wall of the hump (12) of the mounting rim, the bead seat (81) being connected to the side wall by a connecting profile (82),
at least one bead (1) being characterized in that the connecting profile (82) between the bead seat (81) and the side wall (83) of said bead is such that the maximum distance L1 from the center of rotation (41) of the circumferential bead reinforcement (4) to the points on the bead connecting profile (82) and the minimum distance LO from the center of rotation (41) of the circumferential bead reinforcement (4) to the lateral bead profile (83) satisfy the following relationship:
K<1%, where K=(L1−L0)/L1.

2. The tire as claimed in claim 1, characterized in that the ratio K is lower than 0.6%.

3. The tire as claimed in claim 1 or claim 2, characterized in that the ratio K is chosen such that the compressive stresses in that part of the bead that corresponds to the connecting profile (82) are very much lower than the compressive stress in the material of the bead in contact with the rim and corresponding to a compressive deformation of 1%.

4. A method of constructing a profile of a tire bead intended to be mounted on a mounting rim making it possible to reduce the difficulties experienced in mounting the tire on its mounting rim, this mounting rim comprising:
rim seats (11) that are inclined outwards, that is to say that these rim seats have a frustoconical shape, the generatrix of which is inclined with respect to the axis of rotation, the axially outermost points of each generatrix lying on a circle of a diameter smaller than that of the circle on which the axially innermost points of the same generatrix lie, each seat being extended axially outwards by a projection (12) (or hump), this hump having a frustoconical wall, the generatrix of which is inclined in such a way as to be more or less perpendicular to the generatrix of the seat that it extends, said wall generatrix of the hump being, viewed in meridian cross section (that is to say in a plane containing the axis of rotation), connected to the generatrix of the seat by a connecting profile (13) in the form of an arc of a circle of radius R,
the tire comprising
beads (1) designed to come into contact with the mounting rim, each bead comprising a circumferential reinforcement designed to anchor a carcass reinforcement of the tire,
the external profile of the bead, viewed in meridian cross section, comprising a bead seat forming part (81), this part (81) being designed to come into contact with the rim seat (11), this bead seat being extended axially and radially outwards by a side wall (83) designed to come into contact with the frustoconical wall of the hump (12) of the mounting rim,
the method being characterized in that
the profile of the rim, comprising in particular the profile of the seat (11), the profile of the hump (12) and the profile of the connecting profile (13) between the seat and the hump is scanned in a plane containing the axis of rotation;
the circumferential bead reinforcement (4) is placed in the position that it occupies once the tire has been mounted on its rim;
the external bead profile (8) is constructed from the rim profile, that is to say at least partially reproducing the profile of the rim seat and at least partially reproducing the profile of the rim hump, the connecting profile (82) of the bead profile being constructed in such a way that it lies, at least partially, radially on the outside of the connecting profile (13) between the rim seat (11) and the rim hump (12).

5. The method of constructing a bead profile as claimed in claim 4, characterized in that the bead seat (81) and side wall (83) profiles are modified by adding the compressive deformations of the materials of which the bead is made, said deformations being the result of mounting the tire on its rim.
